(19) United States
(12) Patent Application Publication
(10) Pub. No.: US 2026/0000988 A1
(43) Pub. Date: Jan. 1, 2026

(54) Collect Pebbles

(71) Applicant: Elvis N. Makia, Charlotte, NC (US)

(72) Inventor: Elvis N. Makia, Charlotte, NC (US)

(21) Appl. No.: 18/759,813

(22) Filed: Jun. 29, 2024

(51) Int. Cl. A63F 13/573; A63B 67/06; A63F 13/211; A63F 13/2145

(52) U.S. Cl. CPC A63F 13/573; A63B 67/06; A63F 13/211; A63F 13/2145

(57) ABSTRACT

According to one aspect of the present invention disclosed herein, there is provided method of playing a stone toss game, comprising: holding a group of stones in at least one hand; tossing a first stone into the air and while in the air picking up and tossing a second stone; and catching the first tossed stone. According to another aspect of the present invention disclosed herein, there is provided a computer system for playing a stone toss game, comprising: one or more processors; one or more computer memory devices; and a user computer terminal a having first display device and a first input device, wherein the one or more processors are configured to: display a group of stones on the display device; receive an input to toss the group of stones; and receive an input to collect one or more stones.

### BACKGROUND

Games involving tossing objects have been disclosed in the prior art patent literature.

For example, U.S. Pat. No. 11,110,333 discloses a game of toss may include a projectile, a first receptacle, and a second receptacle disposed within the first receptacle, the first and second receptacles for receiving the projectile. The game of toss may involve a player throwing the projectile from a starting position in a direction of the first and second receptacles. Once thrown, the projectile may land in a location external to both the first and second receptacles, at a location within the first receptacle but external to the second receptacle, or at a location within both the first and second receptacles. A scoring system may be devised based on where the projectile lands relative to the first and second receptacles. To change the difficulty of the game of toss, the location of the second receptacle within the first receptacle may be adjusted. For example, the second receptacle may be moved from a central position toward a rearward position such that a separation distance between the player and the second receptacle is increased.

U.S. Pat. No. 7,377,516 discloses a ball tossing game consists of a tossing device that is thrown at a target device. The tossing device may consist of a string or other flexible connector, having a ball on each end thereof. The target has at least one and preferably multiple horizontally-oriented rungs, onto which the tossing device may be wrapped. Additional targets are provided, including a target defined by a vertically oriented post positioned proximate an end of a horizontal rung and perpendicular thereto. In another embodiment, a reduced-length horizontal rung is coupled to at least one of the rungs, and is oriented either above or below the rung. It may be desired to provide, for a single rung, vertically oriented posts and at least one reduced-length horizontal rung.

Patents for video game mechanics related to tossing objects have also been granted.

For example, U.S. Pat. No. 8,251,789 discloses a game apparatus controlling a game in which a user-controlled character and an opponent character hit a ball. A serve control unit receives the first input operation from a user and makes the character perform an action of tossing the ball when the character performs a serve. The serve control unit receives the second input operation from the user and makes the character perform an action of the serve. The serve control unit determines a ball power or ball speed in the serve based on the first input operation, and determines a shot type in the serve based on the second input operation. The serve control unit makes the character perform the serve according to the determined ball power or ball speed and the determined shot type.

U.S. Pat. No. 6,482,086 discloses a computer readable recording medium recording a program of a ball game, which realizes the ball game in which a player handles a movable ball on the ground, the recording medium recording the program for causing a computer to execute: a calculation of a trajectory of the moving ball; a judgement of a height of the ball moving on the calculated trajectory at a present movement position; an indication of a future movement position positioned ahead of the present movement position on a time axis by a mark on the ground, the mark following a movement position of the ball moving on the calculated trajectory; and a change of a size of the displayed mark in accordance with the judged height of the ball at the present movement position.

However, humans are always seeking new forms of entertainment and there remains a need for both novel games that can be played using physical objects and novel video game mechanics.

### SUMMARY OF INVENTION

Therefore, the present invention is a stone toss game system that enables a single player to test their hand and eye coordination in the physical and virtual space by throwing small pebbles into the air or out of their place and then collecting them again in groups. A physical game is provided as well as mechanics for a video game version.

According to one aspect of the present invention disclosed herein, there is provided method of playing a stone toss game, comprising: holding a group of stones in at least one hand; tossing a first stone into the air and while in the air picking up and tossing a second stone; and catching the first tossed stone.

According to another aspect of the present invention disclosed herein, there is provided a computer system for playing a stone toss game, comprising: one or more processors; one or more computer memory devices; and a user computer terminal a having first display device and a first input device, wherein the one or more processors are configured to: display a group of stones on the display device; receive an input to toss the group of stones; and receive an input to collect one or more stones.

### BRIEF DESCRIPTION OF THE DRAWINGS

FIG. 1 is a flow chart depicting the steps in a stone toss game.

FIG. 2 illustrates stones prior to being tossed.

FIG. 3 illustrates stones after being tossed.

FIG. 4 illustrates an electronic embodiment of the stone toss game.

### DETAILED DESCRIPTION

In a stone toss game, initially, a hand full of stones is spread on a surface such as the floor. Then a stone is tossed into the air and while in the air another stone is picked up and the tossed stone is caught. This is then repeated for the other stones still on the surface. In the next round or phase, multiples of two stones are collected while another stone is tossed. This progresses for increasingly larger groups until all of the stones are collected during one toss.

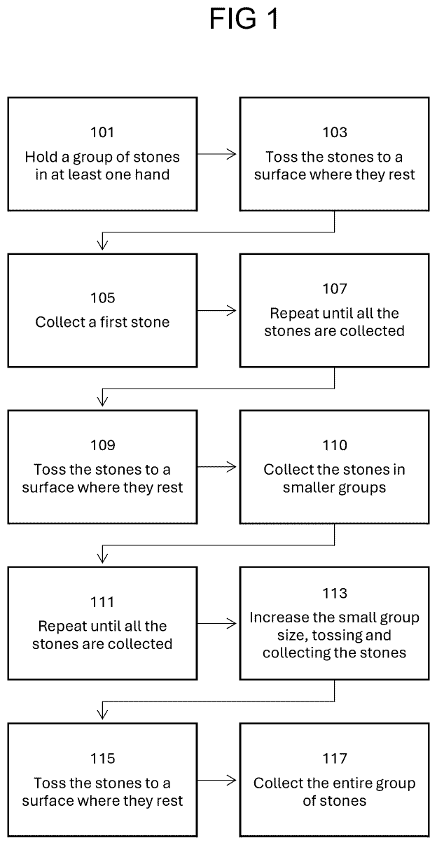

FIG. 1 is a flow chart depicting the steps in a stone toss game.

The first step is holding a group of stones in at least one hand 403.

The next step is tossing the stones to a surface where they rest 405.

The next step is collecting a first stone 407.

The following steps are repeating until all the stones are collected 409.

The next step is tossing the stones to a surface 411.

The next step is collecting the stones in smaller groups 413.

The following steps are repeating until all the stones are collected 415.

The next step is increasing the small group size tossing and collecting the stones 417.

The next step is tossing the stones to a surface 419.

The final step is collecting the entire group of stones 421.

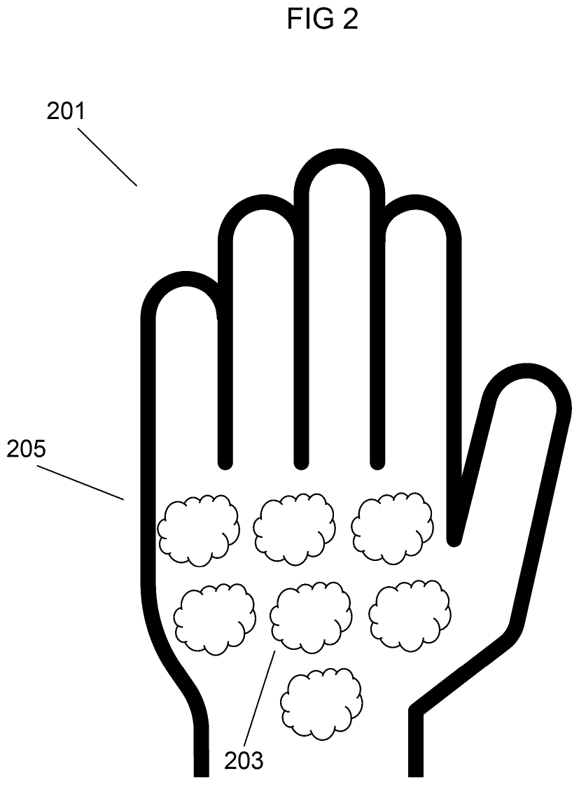

FIG. 2 illustrates stones prior to being tossed.

Stone toss game 201 includes a group of stones 203 that are held in the hands 205 of a player and tossed on the floor or another surface. The player then uses their hands to collect individual stones or a subset of stones from among group of stones 203.

A warm-up challenge where multiple stones are kept in the air before play can be provided. The target could be to keep all the stones, e.g., seven stones as in a preferred embodiment in the air.

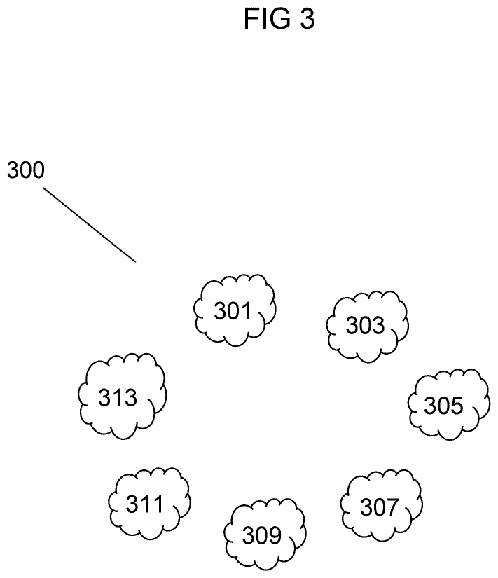

FIG. 3 illustrates stones after being tossed.

Stone toss game system 300 includes a number of stones 301-313 that is a multiple of seven. Initially, a hand full of seven stones is spread on a surface such as the floor.

Then a stone is tossed into the air and while in the air another stone is picked up and the tossed stone is caught. This is then repeated for the other stones still on the surface. In the next round or phase, multiples of two stones are collected while another stone is tossed. This progresses for increasingly larger groups until all of the stones are collected during one toss.

A variety of stones can be used. User can have the option to select stone type can be from a specific family of stones or a mix of stones.

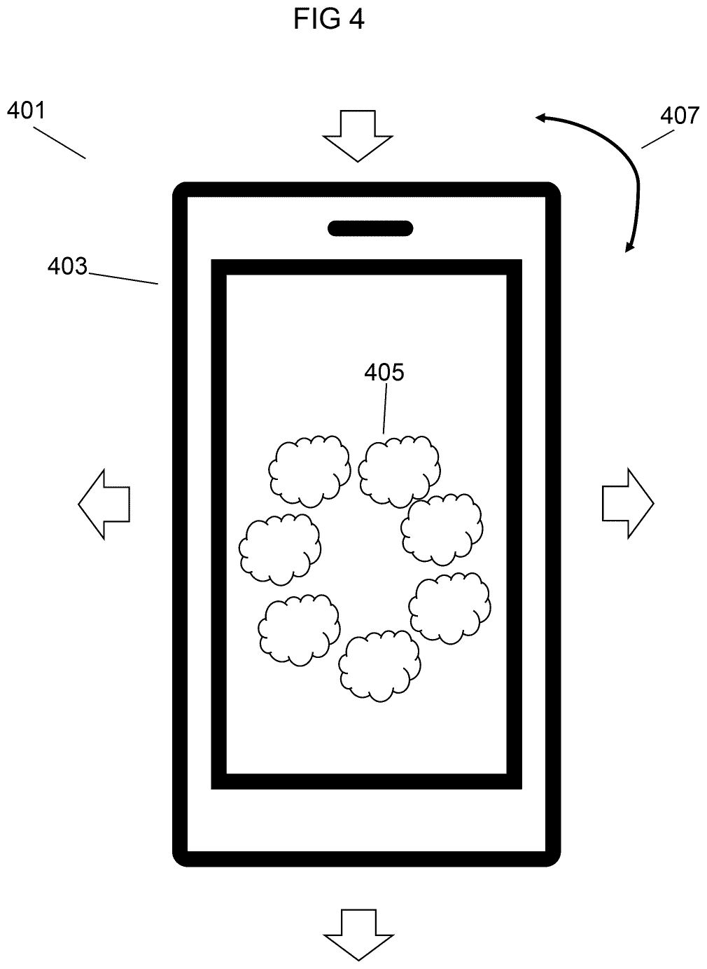

FIG. 4 illustrates an electronic embodiment of the stone toss game.

Embodiment 401 includes a personal computing device 403 with hardware such as a screen and software such as an operating instruction that are configured to display a group of stones 405 thereon so that when a player moves personal computing device 403 in any of multiple directions 407 that group of stones 405 becomes relocated and must be gathered again through additional movements of personal computing device 403. It is also contemplated that interaction by the player with personal computing device 403 through the hardware or software could be required to gather the stones. Group of stones 405 could be collected individually, as a subset of the group, or as an entire group.

Digital stone designs can include cat family stone designs (leopard, cheetah, tiger, jaguar, etc.), miscellaneous stone designs (zebra, giraffe, elephant, etc.), and snake family stone designs (milk snake, coral snake, paradise tree snake, rainbow snake, eyelash viper, etc.).

A warm-up challenge can be displayed where multiple stones are kept in the air before play. The target could be to keep all the stones, e.g., seven stones as in a preferred embodiment in the air.

It is contemplated that motions on the screen replace the physical actions of tossing a stone and collecting others. For example, a swipe upwards could simulate the tossing of a stone. Touches on the remaining stone could replace their collection. A side swipe motion could be used to replace the catch of the falling stone. These are provided solely as examples and not to limit the scope of the embodiment.

In an embodiment, players form words with any 7 letters from the alphabet and 7 stones will fall.

There are three difficulty levels:
5 Consonants and 2 vowels-1 minute level one
6 Consonants and 1 vowel-45 seconds level two
7 consonants and 0 vowels-30 seconds level three

Words formed under given time will be scored.

All of the above embodiments can be performed on a computer system having a memory(s), a processor(s), a display device(s), and an input/output device(s). Additionally, computer readable media storing computer readable code for carrying out the method steps identified above is provided. The computer readable media stores code for carrying out subprocesses for carrying out the methods described above.

A computer program product recorded on a computer readable medium for carrying out the method steps identified above is provided. The computer program product comprises computer readable means for carrying out the methods described above.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A method of playing a stone toss game, comprising:
holding a group of stones in at least one hand;
tossing a first stone into the air and while in the air picking up and tossing a second stone; and
catching the first tossed stone.

2. The method of playing a stone toss game of claim 1, further comprising catching the second tossed stone and repeating the process for the other stones.

3. The method of playing a stone toss game of claim 1, wherein in the next round or phase multiples of two stones are collected while another stone is tossed.

4. The method of playing a stone toss game of claim 3, wherein the process progresses for increasingly larger groups until all of the stones are collected during one toss.

5. The method of playing a stone toss game of claim 1, further comprising a warm-up challenge where multiple stones are kept in the air before play.

6. The method of playing a stone toss game of claim 5, wherein seven stones are kept in the air during the warm-up challenge.

7. A computer system for playing a stone toss game, comprising:
one or more processors;
one or more computer memory devices; and
a user computer terminal a having first display device and a first input device, wherein the one or more processors are configured to:
display a group of stones on the display device;
receive an input to toss the group of stones; and
receive an input to collect one or more stones.

8. The computer system for playing a stone toss game of claim 7, further comprising a motion sensor.

9. The computer system for playing a stone toss game of claim 8, wherein when a user moves the user computer terminal in any of multiple directions a group of stones becomes relocated.

10. The computer system for playing a stone toss game of claim 9, wherein the group of stones is gathered again through additional movements of personal computing device.

11. The computer system for playing a stone toss game of claim 9, wherein a stone is collected individually.

12. The computer system for playing a stone toss game of claim 9, wherein a subset of the group of stones is collected.

13. The computer system for playing a stone toss game of claim 9, wherein the entire group of stones is collected.

14. The computer system for playing a stone toss game of claim 7, wherein motions on the screen replace the physical actions of tossing a stone and collecting others.

15. The computer system for playing a stone toss game of claim 14, wherein a swipe upwards simulates the tossing of a stone.

16. The computer system for playing a stone toss game of claim 14, wherein touches on a stone replicates the collection of the stone.

17. The computer system for playing a stone toss game of claim 14, wherein a side swipe motion is used to replicate the catch of a falling stone.

18. The computer system for playing a stone toss game of claim 7, further comprising displaying a warm-up challenge where multiple stones are kept in the air before play.

19. The computer system for playing a stone toss game of claim 7, further comprising displaying receiving inputs corresponding to words formed with any 7 letters from the alphabet and displaying 7 stones falling.

20. The computer system for playing a stone toss game of claim 19, wherein there are three difficulty levels comprising 5 consonants and 2 vowels in 1 minute, 6 consonants and 1 vowel in 45 seconds, 7 consonants and 0 vowels in 30 seconds and wherein words formed under given time will be scored.
